(19) United States
(12) Patent Application Publication
(10) Pub. No.: US 2014/0070564 A1
(43) Pub. Date: Mar. 13, 2014

(54) AIR FLOW CONTROL ASSEMBLY FOR A MOTOR VEHICLE

(71) Applicant: Hendrickson USA, L.L.C., Itasca, IL (US)

(72) Inventor: Brian Bernard, Woodridge, IL (US)

(21) Appl. No.: 13/839,999

(22) Filed: Mar. 15, 2013

Related U.S. Application Data
(60) Provisional application No. 61/699,583, filed on Sep. 11, 2012.

(51) Int. Cl. B62D 35/00

(52) U.S. Cl. CPC B62D 35/001; B62D 35/005
USPC 296/180.3

(57) ABSTRACT

An air flow control assembly for a motor vehicle is disclosed that includes an air dam component at the front of the vehicle, typically mounted to the front bumper, which extends substantially across the width of the bumper. It includes a rearwardly extending generally planar surface that is configured to underlie the interior space at the front of the vehicle as well as an engine compartment underpanel which is coupled to that air dam and underlies the vehicle engine compartment.

This application claims the benefit of U.S. Provisional Patent Application Ser. No. 61/699,583, filed Sep. 11, 2012, the disclosure of which is hereby incorporated by reference in its entirety.

### FIELD OF THE INVENTION

The present disclosure generally relates to air flow control assemblies for motor vehicles and, more particularly, to air dams and engine compartment underpanels for motor vehicles. In this regard, an important aspect of this disclosure is directed to air dam and engine compartment underpanel assemblies for improving the aerodynamic characteristics of motor vehicles including, in particular, trucks and truck tractors.

### BACKGROUND OF THE DISCLOSURE

It is known that the aerodynamic characteristics of motor vehicles can be improved by an air dam which typically is mounted to the front of a motor vehicle and extends downwardly into proximity with the roadway.

For example, U.S. Pat. No. 4,291,911 (Gallmeyer) describes an air dam apparatus which is particularly concerned with trucks and truck tractors. That air dam apparatus comprises a pivotally mounted flat doorlike panel which, when deployed into an operative position below the front bumper deflects air from the front to the sides of the vehicle. Correspondingly, U.S. Pat. No. 7,871,121 (Ragsdale) describes a flexible flat plastic panel which extends downwardly from the bumper of a truck, redirecting air flow around the sides of the wheels.

Neither of these prior art air dams is capable of guiding air streams that impinge on the front of the vehicle in a manner which effectively reduces turbulence in both the engine compartment and interior areas forwardly thereof in the vehicle.

This design inadequacy and other shortcomings of the prior art are successfully addressed by the novel air flow control assembly described herein.

### SUMMARY OF THE INVENTION

This disclosure is directed to an air flow control assembly for improving the aerodynamic characteristics of a motor vehicle by providing an air dam component at the front of the vehicle, typically mounted to the front bumper, which extends substantially across the entire width of the bumper and includes a rearwardly extending, generally planar surface that is configured to underlie the interior space at the front of the vehicle which is forward of the engine compartment, as well as an engine compartment underpanel component which is coupled to that air dam and underlies the vehicle engine compartment. These components of the assembly cooperate to route air flow when the vehicle is traveling at relatively high speeds so that it passes below the vehicle in a manner which effectively reduces turbulence and drag in both that interior space at the front end of the vehicle and in the engine compartment. As such, this air flow control assembly provides, among other things, enhanced fuel efficiency.

In accordance with an important aspect of the present disclosure, the engine compartment underpanel component can be coupled to the air dam component mounted forwardly thereof by a plurality of fasteners such as, for example, plastic rivets which, optionally, can be of the type which are releasable and reusable for facilitating removal of the underpanel when service to the engine and other components in the engine compartment is desired and the engine compartment underpanel reattached thereafter.

Another aspect of this disclosure concerns a tear-away feature for preventing damage to the air dam and/or engine compartment underpanel when either or both of them are contacted by a road obstacle. This feature is achieved by the use of fasteners which are designed to shear when a road obstacle is contacted by the air dam and/or engine compartment underpanel resulting in a force of predetermined magnitude is imparted to either of these components without significant, if any, damage thereto.

It is to be understood that the foregoing general description and the following detailed description are exemplary and are provided for purposes of explanation only. Other features, benefits and objects of the air flow control assembly of this disclosure will be apparent to those skilled in this art from these descriptions. Accordingly, the invention is to be limited only by the scope of the appended claims.

### DESCRIPTION OF THE DRAWINGS

In describing the features of the disclosed embodiment, reference is made to the accompanying drawing figures wherein like parts have like reference numerals and wherein:

FIG. 1 is a front lower perspective view of the air dam and engine compartment underpanel of the present disclosure;

FIG. 2 is a rear upper perspective view of the air flow control assembly shown in FIG. 1;

FIG. 3 is an exploded front perspective view separately showing the bumper, air dam and engine compartment underpanel, as well as the individual fasteners used to interconnect the same;

FIG. 4 is a top plan view of the air dam component of the subject air flow control assembly;

FIG. 5 is a front elevational view of the air dam shown in FIG. 4;

FIG. 6 is an upper rear perspective view of the air dam shown in FIG. 4;

FIG. 7 is a side elevational view of the air dam shown in FIG. 4;

FIG. 8 is a top plan view of the engine compartment underpanel of the air flow control assembly of this disclosure;

FIG. 9 is a rear elevational view of the engine compartment underpanel shown in FIG. 8;

FIG. 10 is an upper rear perspective view of the engine compartment underpanel shown in FIG. 8;

FIG. 11 is a side elevational view of the engine compartment underpanel shown in FIG. 8;

FIG. 12 is a side elevational schematic view of an installed air flow control assembly of this disclosure;

FIG. 13 is a bottom plan schematic view of an installed air flow control assembly of this disclosure.

### DETAILED DESCRIPTION

Referring to the drawings, the reference numeral 20 generally designates an air flow control assembly of the present invention which includes an air dam component 21 and an engine compartment underpanel component 22, which assembly, in the illustrated embodiment, is coupled to a bumper 23. For example in the illustrated embodiment, bumper 23 includes a pair of tow hook holes 24, 25 and engine ventilation apertures 26, 27 and 28. It will be appreciated that the present invention is not limited to any particular bumper design and construction.

Air dam component 21 and engine compartment underpanel component 23 can be composed of a variety of materials including plastics, metal, fiberglass and composites, as well as other like materials known to those skilled in the art. It can be formed by injection molding, thermal forming, stamping or other manufacturing methods also known to those skilled in the art.

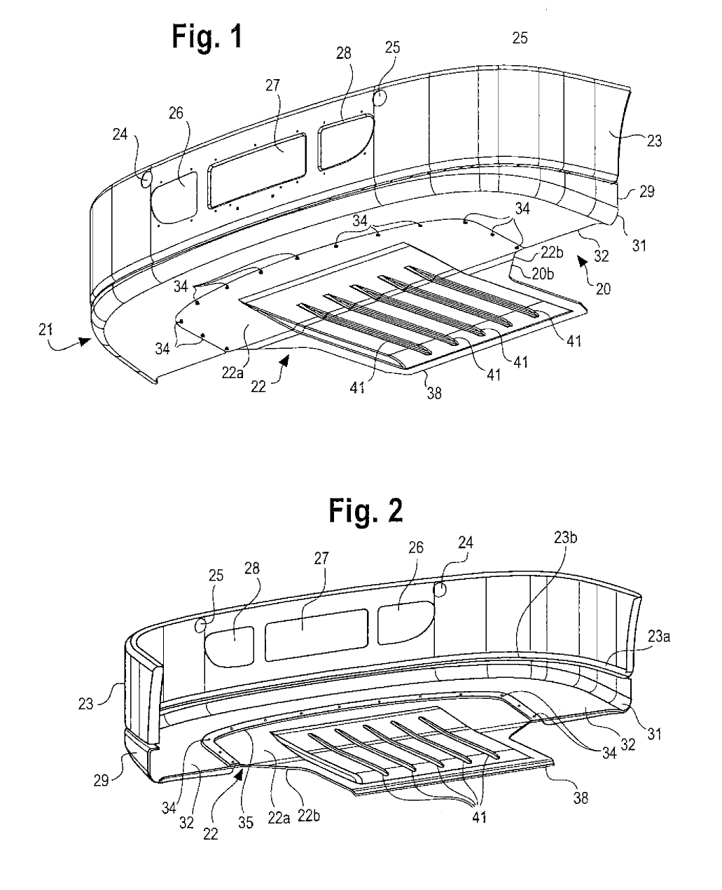

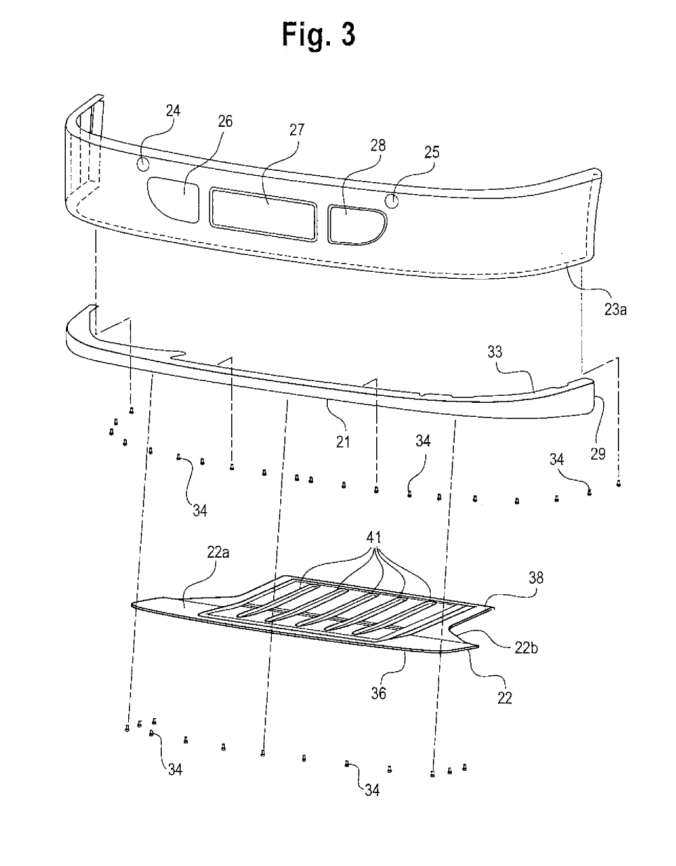

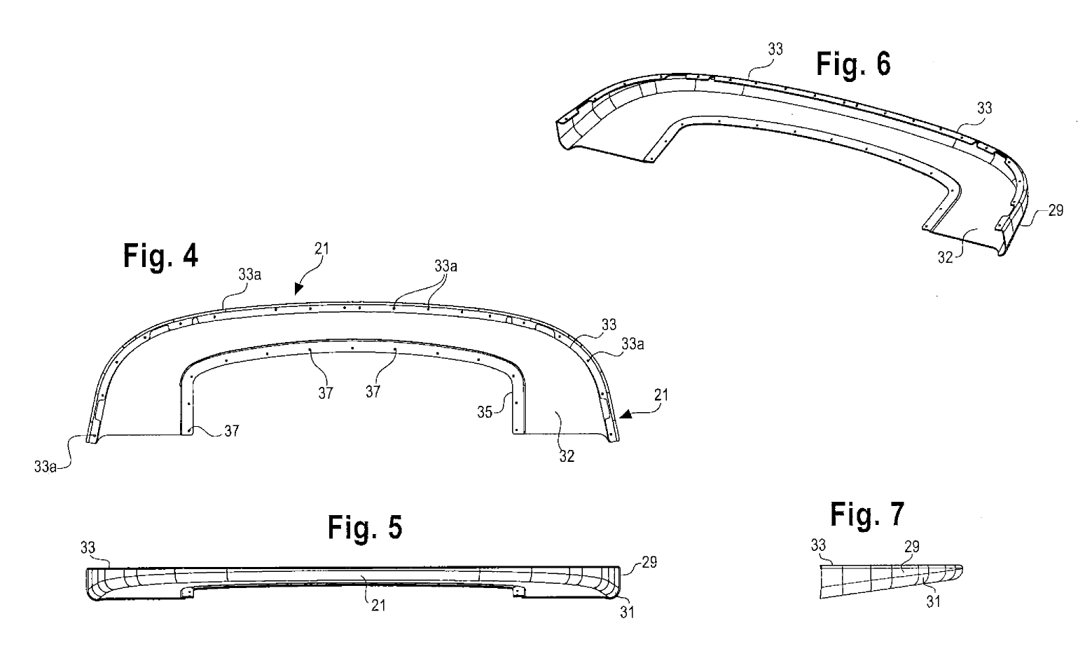

As best shown in FIGS. 1-7, the air dam component 21 includes a front facing downwardly extending trim portion 29 which, at its lower end, extends into a curved portion 31 that, in turn, extends into a U-shaped rearwardly extending generally continuous planar surface 32 which is configured to underlie the interior space at the front end of the vehicle. Air dam component 21 can be secured to the bumper 23 by an inwardly extending peripheral mounting flange 33 at its upper edge which is configured to be attached to a mating inwardly extending mounting flange 23a on the lower portion of the bumper 23 by means of a plurality of fasteners 34 which are received in apertures 33a of air dam mounting flange 33 and correspondingly sized and spaced apertures 23b of bumper mounting flange 23a.

In the illustrated embodiment, the back portion of U-shaped planar portion 32 includes a raised mounting flange 35 which is configured to receive the forwardmost portion 36 of engine compartment underpanel component 22. This permits the underpanel component to be received in flush relationship to the bottom surface of U-shaped planar portion 32 of air dam 21. A plurality of fasteners 34 similar to those used in coupling the air dam 21 to the bumper 23 can be used to attach engine compartment underpanel component 22 to mounting flange 35 which extends through apertures 37 in mounting flange 35 and like-sized and spaced-apart apertures 37 in the forward end 36 of engine compartment underpanel component 22.

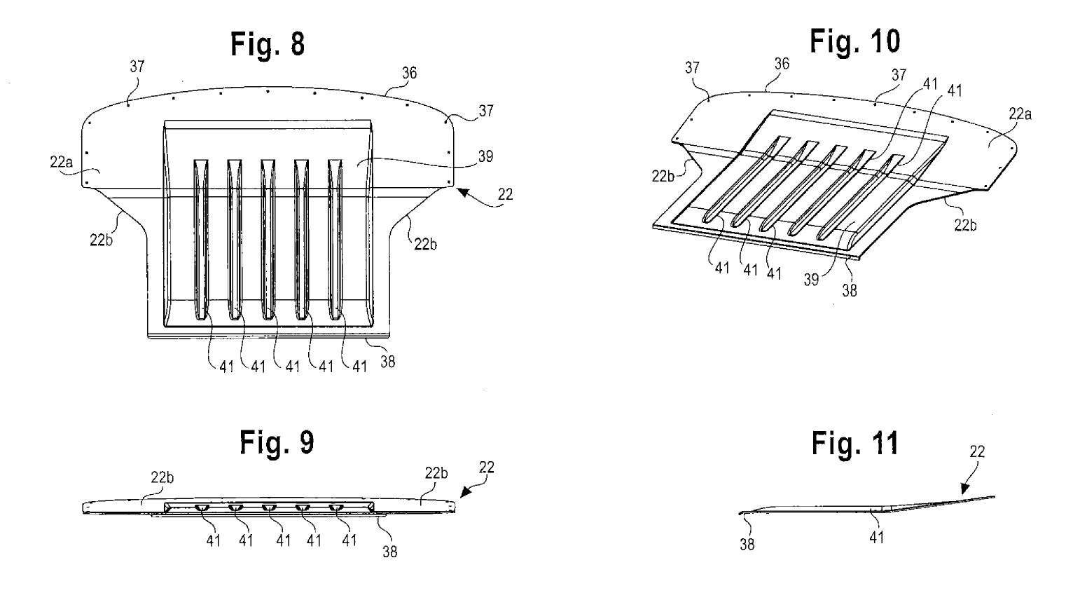

As shown in FIGS. 1, 2 and 8-11, engine compartment underpanel 22 can be provided with a generally flat perimeter portion 22a that extends rearwardly terminating in a downwardly curled lip 38. A generally rectangular center portion 39 surrounds perimeter portion 22a and is downwardly tapered from the forward end to the rearward end. A plurality of longitudinal raised ribs 41 can be provided to add rigidity to the engine compartment underpanel component 22.

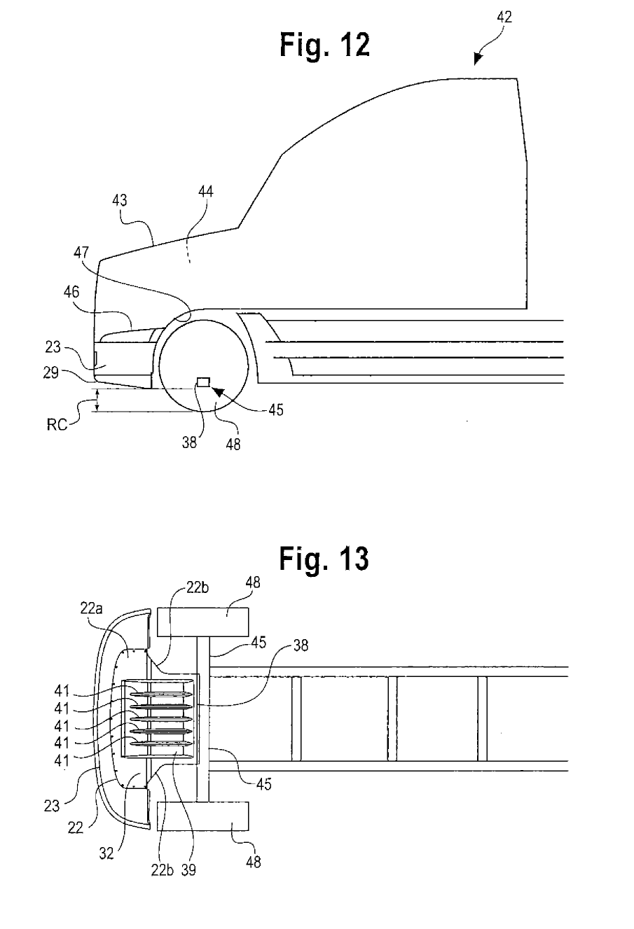

FIGS. 12 and 13 schematically illustrate the orientation of the air flow control assembly 20 of the present disclosure in a truck 42 having a hood 43 that encloses an engine compartment 44, a front axle 45 and the front bumper 23 to which the trim portion 29 of air dam component 21 is coupled. Desirably, a top filler panel 46 on the topsurface of bumper 23 adjacent wheel well 47 can be provided to limit the flow of air into the wheel well. As shown in FIGS. 12 and 13, the back edge curl 38 of engine compartment underpanel component 22 preferably terminates slightly forwardly front axle 45 so as to avoid contact with the axle 45 when the vehicle is traveling along a roadway and the front end of the truck moves vertically as a result of contact by the tires 46 with irregularities in the roadway.

Perimeter portion 22a of engine compartment underpanel component 22, as shown in FIG. 13, includes inwardly tapered sides 22b which can accommodate angular movement of the tires 48 during right and left turns. In this regard, it will be appreciated that a common design for engine compartment underpanel 22 can be used with a variety of air dam component designs that are individually styled to accommodate the varied multiple truck platforms of different manufacturers.

The road clearance between the air flow control assembly 20 of this disclosure designated by the fetters “RC” in FIG. 12 should be as low as needed for the desired aerodynamic performance with sufficient clearance above the road to minimize possible damage to the air dam component and/or the engine compartment underpanel component by impact with obstacles. In this regard, there should be a minimum clearance of at least approximately six inches between the lowermost portion of the air dam component 21 and engine compartment underpanel component 22 with the ground. Generally, however, it is believed that a road clearance of approximately eight to eleven inches will be suitable for most installations.

An important feature of this disclosure, concerns the ready removal of the engine compartment underpanel component 22 when access to the engine compartment is desired. This is facilitated by the use of fasteners such as, for example, plastic rivets which can be of a type which are releasable and reusable for facilitating removal of the underpanel when service to the engine and other components in the engine compartment is desired. These same rivets or replacements thereof can then be used for reattachment of that underpanel when such servicing of the engine compartment is completed.

If desired, the fasteners 34 can be of a type which are designed to shear when a road obstacle is contacted by either the air dam component or engine compartment underpanel component contact a road obstacle, resulting in a force of predetermined magnitude being imparted to the particular component involved and enabling that component to separate from the assembly without significant, if any, damage to the particular assembly component involved.

While the invention of this disclosure has been described in accordance with a preferred embodiment, it will be appreciated by those skilled in the art that modifications and/or changes may be made to the foregoing description without departing from the spirit and scope of this invention. Accordingly, the invention of this disclosure is not limited by this disclosure but rather by the scope of the appended claims.

I claim:

1. An air flow control assembly for improving the aerodynamic characteristics of a motor vehicle having a front bumper, an engine compartment disposed rearwardly thereof and a front axle, comprising:
an air dam component attached to said motor vehicle adjacent a lower portion of said front bumper and extending substantially across the entire width of said bumper, said air dam component including a rearwardly extending, generally planar surface configured to underlie an interior space at the front end of said vehicle which is rearward of said front bumper and forward of said engine compartment;
an engine compartment underpanel component, configured to underlie the vehicle engine compartment, is coupled to said air dam, said engine compartment underpanel component having a forward edge which extends rearwardly from a back edge of said air dam component and terminates in a rear edge which is forward of said front axle; and
said air dam and engine compartment underpanel components cooperating to route air flow when said vehicle is traveling at relatively high speeds below the vehicle in a manner which minimizes turbulence and drag in said interior space at the front end of said vehicle and said engine compartment.

2. The air flow control assembly of claim 1 wherein said engine compartment underpanel component is detachably connected to said air dam component to provide selective access to the engine compartment when desired.

3. The air flow control assembly of claim 1 wherein said air dam component includes an inwardly extending, peripheral mounting flange along its forward upper edge which is configured to be attached to a mating, inwardly extending flange on the lower portion of the front bumper by a plurality of spaced-apart fasteners which are designed to shear when a road obstacle is contacted by said air dam component, resulting in a force of predetermined magnitude being imparted to said air dam, causing it to separate from the bumper without significant, if any, damage to said air dam.

4. The air flow control assembly of claim 3 wherein said fasteners are plastic rivets.

5. The air flow control assembly of claim 1 wherein said back edge of said air dam component includes a peripheral flange which is configured for connection to the forward edge of said engine compartment underpanel component and a plurality of spaced-apart fasteners secure said back edge of said air dam to said forward edge of said engine compartment underpanel.

6. The air flow control assembly of claim 5 wherein said fasteners are quick release and reusable plastic rivets facilitating removal and reattachment of said engine compartment underpanel.

7. The air flow control assembly of claim 5 wherein said spaced-apart fasteners are designed to shear when a road obstacle is contacted by said engine compartment underpanel, resulting in a force of predetermined magnitude being imparted to said engine compartment underpanel, causing it to separate from the air dam without significant, if any, damage to said engine compartment underpanel.

8. The air flow control assembly of claim 1 wherein the road clearance between the bottom most portion of said air dam and engine compartment underpanel components are at least approximately six inches.

9. The air flow control assembly of claim 9 wherein the said road clearances are from approximately eight to eleven inches.

10. The air flow control assembly of claim 1 wherein said engine compartment underpanel component includes structural ribs for providing improved rigidity to said panel.

11. The air flow control assembly of claim 1 wherein said air dam and engine compartment underpanel components are integrally formed.

12. An air flow control assembly for improving the aerodynamic characteristics of a motor vehicle having a front bumper, an engine compartment disposed rearwardly thereof, and a front axle adjacent a rear portion of the engine compartment, comprising:
an air dam component attached to a lower portion of said front bumper and extending substantially across the entire width of said bumper, said air dam including a rearwardly extending generally continuous planar surface configured to underlie the interior space at the front end of the vehicle which is rearward of said front bumper and forward of said engine compartment;
an engine compartment underpanel component detachably coupled to said air dam component, said underpanel component having a forward edge which extends rearwardly from a generally centrally located back edge of said air dam component and terminates in a rear edge which is forwardly of said front axle, said underpanel component being configured to underlie at least a substantial portion of said vehicle engine compartment; and
said air dam and engine compartment underpanel components cooperating to route air flow when said vehicle is traveling at highway speeds below the vehicle in a manner which minimizes turbulence and drag in the interior space at the front end of said vehicle and in said engine compartment.

13. The air flow control assembly of claim 12 wherein said motor vehicle is a truck or truck tractor.

14. The air flow control assembly of claim 12 when said air dam component includes an inwardly extending peripheral mounting flange along its forward upper edge which is configured to be attached to a mating inwardly extending flange on a lower portion of the front bumper by a plurality of spaced-apart fasteners which are designed to shear when a road obstacle is contacted by said air dam, resulting in a force of predetermined magnitude being imparted to said air dam and causing it to separate from said bumper without significant, if any, damage to said air dam.

15. The air flow control assembly of claim 14 wherein said fasteners are plastic rivets.

16. The air flow control assembly of claim 12 wherein said back edge of said air dam component includes a peripheral flange that is configured for connection to the front edge of said engine compartment underpanel component and a plurality of spaced-apart fasteners secure said back edge of said air dam component to said forward edge of said engine compartment underpanel component.

17. The air flow control assembly of claim 16 wherein said spaced-apart fasteners are designed to shear when a road obstacle is contacted by said engine compartment underpanel component, resulting in a force of predetermined magnitude being imparted to said engine compartment underpanel, and causing it to separate from the air dam component without significant, if any, damage to said engine compartment underpanel component.

18. The air flow control assembly of claim 16 wherein said fasteners are releasable and reusable plastic rivets for facilitating removal and reattachment of said engine compartment underpanel.

19. The air flow control assembly of claim 12 wherein the road clearance between the bottom of said air dam and said engine compartment underpanel is at least approximately six inches.

20. The air flow control assembly of claim 19 wherein said road clearance is from approximately eight to eleven inches.

21. The air flow control assembly of claim 12 wherein said engine compartment underpanel component includes ribs providing improved rigidity to said underpanel component.

22. The air flow control assembly of claim 12 wherein said air dam and engine compartment underpanel components are integrally formed.
